(19) United States
(12) Patent Application Publication
(10) Pub. No.: US 2018/0184590 A1
(43) Pub. Date: Jul. 5, 2018

(54) LAWN MOWER

(71) Applicant: MAKITA CORPORATION, Anjo-shi, Aichi (JP)

(72) Inventors: Noriaki TAKAHASHI, Anjo-shi (JP); Takahiro KAMIYA, Anjo-shi (JP); Tetsuya KIUCHI, Anjo-shi (JP)

(73) Assignee: MAKITA CORPORATION, Anjo-shi, Aichi (JP)

(21) Appl. No.: 15/740,675

(22) PCT Filed: Jul. 15, 2016
(86) PCT No.: PCT/JP2016/070957

§ 371 Date: Dec. 28, 2017

(30) Foreign Application Priority Data
Jul. 23, 2015 (JP) 2015-145575

(51) Int. Cl. A01D 34/68; A01D 34/71

(52) U.S. Cl. CPC A01D 34/68; A01D 34/71

(57) ABSTRACT

A lawn mower having a lateral-side discharge outlet in a body housing for discharging mowed lawn has been configured such that a discharge outlet door for closing the lateral-side discharge outlet is held at a closed position only by a spring force, and therefore, there has been a risk of causing fluttering due to a blowing pressure and vibrations generated by the rotation of a mowing blade. An object of the present invention is to avoid fluttering of the discharge outlet door.

In order to avoid fluttering, a lock device (20) is disposed at a discharge outlet door (16) for locking it at a closed position. The lock device (20) is unlocked by an unlock operation by the user, so that accidental opening can be prevented. By setting a spring to be weak, the discharge outlet door (16) can be easily opened.

### TECHNICAL FIELD

The present disclosure relates to a lawn mower that may be used for a mowing operation, etc. of a lawn.

### BACKGROUND ART

A lawn mower may be provided with a mowing blade rotated by an engine or an electric motor and disposed at a housing having wheels, and a handle is disposed at the rear portion of the housing and is adapted to be grasped by the user for a moving operation of the lawn mower. The mown lawn may be collected within a grass collection box provided at the rear portion of the housing or may be discharged from a discharge outlet disposed at the lateral portion of the housing. The technique relating to the lawn mower is disclosed in JP-A-H9-201125 and JP-A-2010-11743. Typically, as lawn mowers, there have been proposed reel blade type ones incorporating as a mowing blade a cylindrical reel blade rotating about an axis that is parallel to a lawn surface (ground), and rotary blade type ones incorporating as a mowing blade a disk-shaped or a blade-shaped rotary blade rotating about an axis that is perpendicular to a lawn surface, and the latter rotary blade type lawn mowers are disclosed in the aforementioned patent documents.

In the case of the rotary blade type lawn mowers, there have been proposed ones that are provided with a grass collecting boxed at a rear portion of a housing for collecting the mown lawn similar to the reel blade type ones, and that are also proposed ones that can directly discharge the mown lawn from a lateral portion of a housing. In this case, a discharge outlet door for opening and closing a discharge outlet that is opened at the lateral portion of the housing.

In the case that the mown lawn is collected within the grass collecting boxed at the rear portion, the discharge outlet at the lateral portion is closed by the discharge outlet door. On the other hand, in the case that the grass collecting box at the rear portion is detached and the mown lawn is discharged from the discharge outlet at the lateral portion, the discharge outlet door is opened. Typically, the discharge outlet door is biased in a closing direction by a biasing means, such as a torsion spring. Therefore, the discharge outlet door is configured such that it is opened by hand against the biasing means and is closed by the biasing means when the hand is released. In the case that the mown lawn is discharged from the discharge outlet at the lateral portion, a discharge duct is attached to the discharge outlet that is opened.

The discharge outlet door in the related art has the following problem. The discharge outlet door is biased in the closing direction by a torsion spring, etc. that provides a relatively strong resilient force in order to avoid fluttering caused by a wind pressure generated by the rotation of the mowing blade. Therefore, a relatively large force is necessary for opening the discharge outlet door, and there has been a problem that the operability of the discharge outlet door is low in this respect. There has been a need in the art to improve the operability of the discharge outlet door by making it easier to open and close the discharge outlet door.

### SUMMARY

In one aspect according to the present disclosure, a lawn mower may comprise a rotary mowing blade and a housing covering a periphery of the mowing blade. A discharge outlet for discharging lawn mown by the mowing blade, a discharge outlet door for opening and closing the discharge outlet, and a lock device for locking a closed state of the discharge outlet door may be disposed at the housing.

With this construction, the discharge outlet door is locked at a closed position by the lock device. Therefore, the discharge outlet door may not cause fluttering by a blowing pressure generated by the rotation of the mowing blade even in the case where a biasing force in a closing direction is sent to be weak. Because the basing force in the closing direction can be sent to be weak without leading to cause fluttering by the rotation of the mowing blade, the discharge outlet door can be easily opened by a smaller force than require in the prior art, and therefore, in this respect, it is possible to improve the operability of the discharge outlet door.

Further, because the discharge outlet door is locked at the closed position by the lock device, it is necessary to unlock the lock device for opening the discharge outlet door, and as a result, it is possible to avoid accidental opening of the discharge outlet door.

The discharge outlet door may be biased in a closing direction, and the lock device may be locked when the discharge outlet door is closed by the biasing force.

With this construction, when the discharge outlet door is closed, it may be automatically locked at the closed position by the lock device. Therefore, the discharge outlet door is not left at the open state, and the discharge outlet door is always kept in a state where it is locked at the closed position unless the user performs an unlock operation.

The discharge outlet may be disposed at least one of a rear portion and a lateral portion of the housing.

Therefore, it is possible to improve the operability in opening the discharge outlet door for at least one of the discharge outlets at the rear portion and the lateral portion of the housing.

The mowing blade may be stopped when the lock device is operated to be unlocked.

Therefore, it is possible to always achieve a state where the rotation of the mowing blade is stopped when the discharge outlet door is opened.

The discharge outlets may be disposed in both of the rear portion and the lateral portion of the housing and may be each provided with the discharge outlet door and the lock device. When one of the lock devices is unlocked and the discharge outlet door is opened, the other discharge outlet may be closed and a closed state of the same may be automatically locked by the lock device.

The discharge outlet door may be configured such that only one of the discharge outlet in the rear portion and the discharge outlet in the lateral portion is opened, so that it is possible to certainly avoid the state where both of them are opened.

### BRIEF DESCRIPTION OF THE DRAWINGS

FIG. 1 is a right-side view of a lawn mower according to an embodiment.

FIG. 2 is a plan view of the entire lawn mower according to the embodiment.

FIG. 3 is a right-side view of a body portion showing a front view of a discharge outlet door.

FIG. 4 is a cross sectional view taken along line (IV)-(IV) in FIG. 3 showing a horizontal sectional view of a lock device according to a first embodiment.

FIG. 5 is a vertical sectional view of a lock device according to a second embodiment.

FIG. 6 is a vertical sectional view of a lock device according to a third embodiment.

FIG. 7 is a front view of a lock device according to a fourth embodiment.

FIG. 8 is a front view of a lock device according to a fifth embodiment.

FIG. 9 is a horizontal sectional view of a lock device according to a sixth embodiment.

FIG. 10 is a side view of a discharge outlet door according to another configuration. In this figure, a right side surface and a rear surface of a body portion are shown in developed forms.

### DETAILED DESCRIPTION

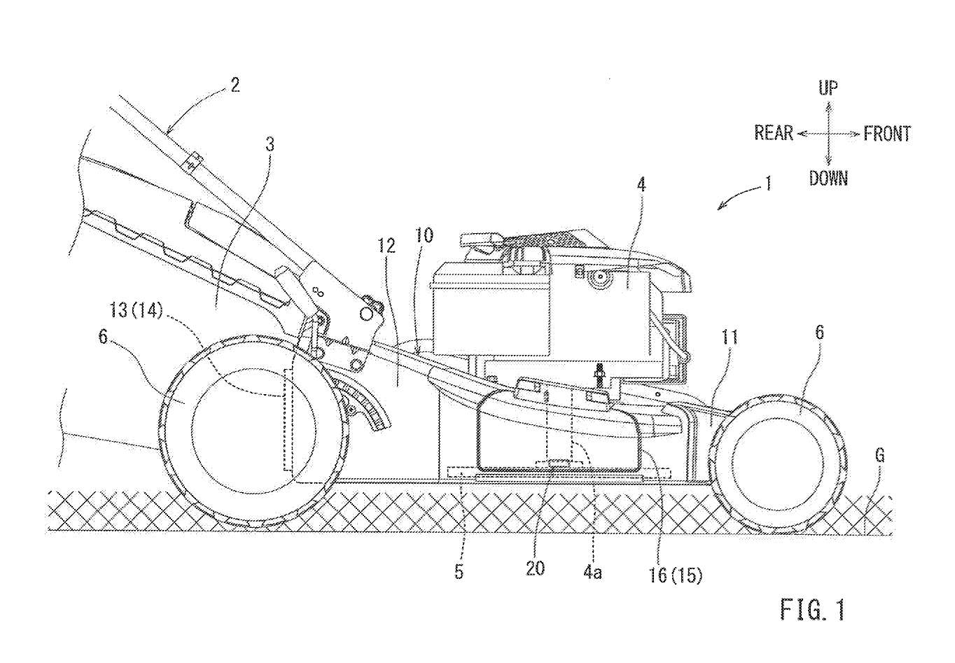

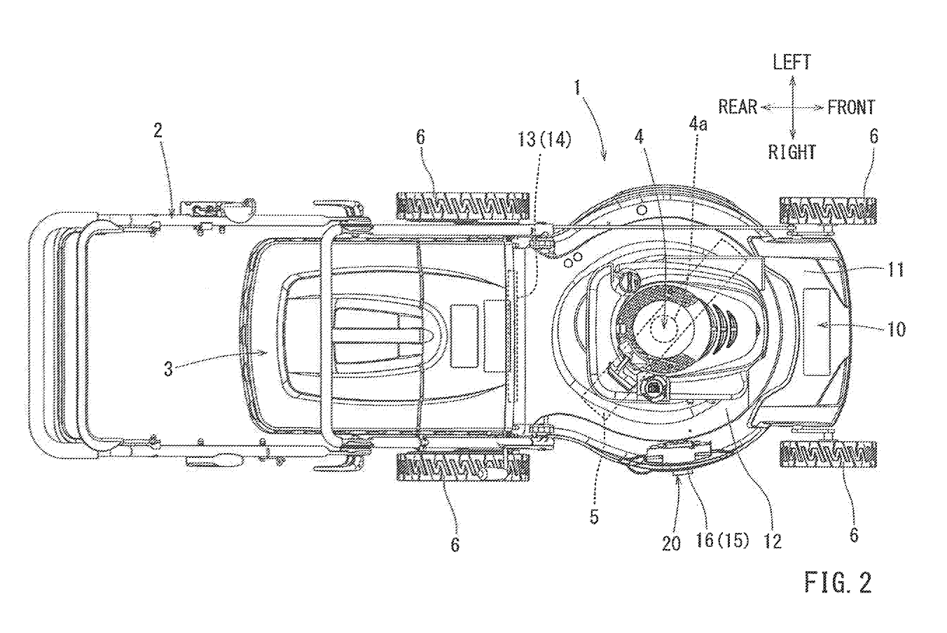

An embodiment of the present disclosure will now be described with reference to FIGS. 1 to 10. As shown in FIGS. 1 and 2, a lawn mower 1 of this embodiment may be provided with a body portion 10 and a handle portion 2. The body portion 10 may include a deck portion 11 supporting front, rear, left and right wheels 6, and a resin-made body housing 12 attached in such a manner that it covers the upper side of the deck portion 11.

The handle portion 2 may have a frame shape and may extend obliquely upward from the rear portion of the main body 10. The user can perform a lawn mowing operation, etc. by grasping the handle portion 2 and pushing it forward while the user is positioned on the side of the rear portion of the lawn mower 1. In the following description, left and right directions with respect to parts and constructions will be referred with reference to the user.

The lawn mower 1 of this embodiment may be provided with an engine 4 including an internal combustion engine as a power source. The engine 4 is mounted to the upper surface of the body housing 12 at a substantially central position thereof. A mowing blade 5 may be attached to an output shaft 4a of the engine 4. The output shaft 4a of the engine 4 may be arranged in such a state that it extends substantially perpendicular to a lawn surface G. The mowing blade 5 rotates horizontally about the output shaft 4a.

The lawn, etc. mown by the mowing blade 5 may be stored in a grass collecting box 3 provided on the rear portion of the body housing 12. The grass collecting box 3 can be detached. By detaching the grass collecting box 3 from the body portion 10, the collected lawn can be easily discarded. In the state where the grass collecting box 3 has been removed, a rear-side discharge outlet 13 formed to be opened in the rear portion of the body housing 12 is closed by a closure member 14.

The lower surface side portion of the body housing 12 may be largely opened in a cylindrical tubular shape toward the lawn surface G, and the mowing blade 5 may be horizontally arranged on the inner circumferential side of the tubular shape. The left and right sides of the mowing blade 5 are covered by the left and right side portions of the body housing 12. A lateral-side discharge outlet 15 is provided on the right side portion of the body housing 12. The lawn that has been mown by the mowing blade 5 is blown laterally by the rotational force of the mowing blade 5. The blown lawn is thrown against the inner surface of the body housing 12. The lawn blown into the rear portion of the body housing 12 is collected within the grass collecting box 3 via the rear-side discharge outlet 13.

The lawn blown rightward by the rotation of the mowing blade 5 may be discharged to the outside of the body housing 12 via the lateral-side discharge outlet 15. When the lateral-side discharge outlet 15 is used for discharging, the grass collecting box 3 is detached from the rear-side discharge outlet 13 and the rear-side discharge outlet 13 is closed by the exclusively used cover member 14 as described previously. On the other hand, when the rear-side discharge outlet 13 is used, the lateral-side discharge outlet 15 is closed by a discharge outlet door 16.

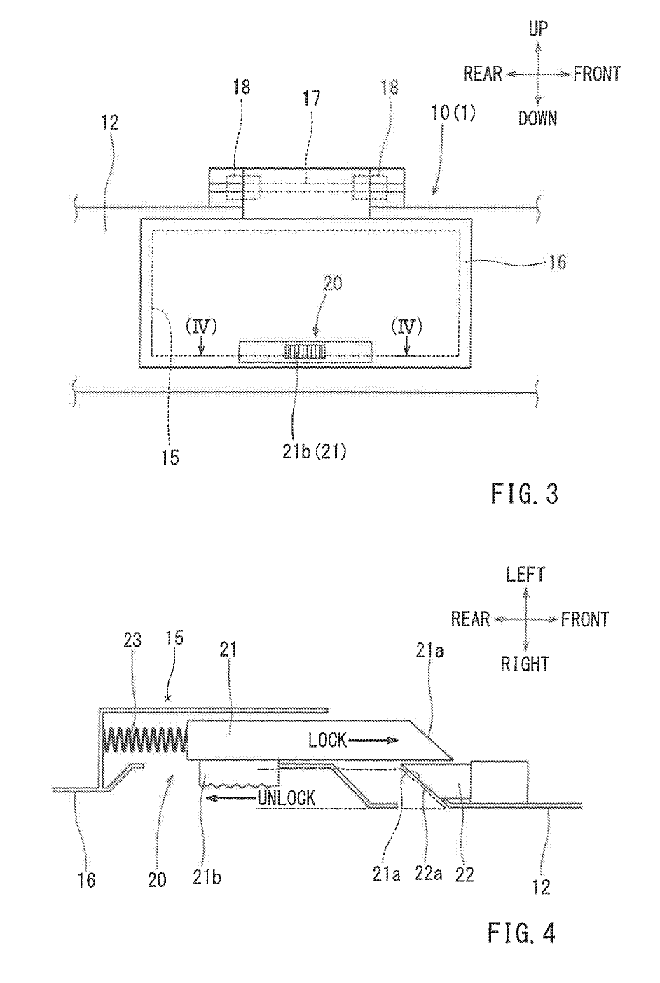

As shown in FIG. 3, the discharge outlet door 16 for the lateral-side discharge outlet 15 may be supported by the body housing 12 via a support shaft 17 and can be opened and closed in the up-to-down direction. The discharge outlet door 16 may be biased in a downward pivoting direction (closing direction) by a torsion spring 18. The user can open the discharge outlet door 16 by engaging his fingertips with the lower portion of the discharge outlet door 16 and pivoting it upward against the torsion spring 18. If the engaged fingertips are released, the discharge outlet door 16 pivots downward and is closed by the biasing force of the torsion spring 18. A discharge duct, the illustration of which is omitted, can be attached to the lateral-side discharge outlet 15 by opening the discharge outlet door 16 upward. The lawn mown by the mowing blade 5 is discharged laterally rightward of the lawn mower 1 via the lateral-side discharge outlet 15 and the discharge duct.

The discharge outlet door 16 of the lateral-side discharge outlet 15 may be provided with a lock device for locking the door in a closed state. A schematic construction of a lock device 20 according to a first embodiment is shown in FIG. 4. The lock device 20 of the first embodiment is provided with a lock member 21 disposed on the side of the discharge outlet door 16, and a lock receiving portion 22 disposed on the side of the lateral-side discharge outlet 15. The lock member 21 is supported by the lower portion of the discharge outlet door 16 such that it can move in the front-to-rear direction. The lock member 21 is biased forward (lock side) by a compression spring 23. A guide inclined surface 21a is provided on a tip end portion of the lock member 21. A knob portion 21b is provided on a lateral portion of the lock member 21. The knob portion 21b protrudes toward the front surface side of the discharge outlet door 16. A slip-preventing treatment is applied on the knob portion 21b. The user can slide the lock member 21 in the front and rear directions by pinching the knob portion 21b. The lock receiving portion 22 is fixed to the side of the lateral-side discharge outlet 15 (i.e., fixed to the body housing 12). A guide inclined surface 22a is provided on a tip end of the lock receiving portion 22.

FIG. 4 shows a lock state of the lock device 20. In the lock state, the tip end portion of the lock member 21 enters the inner side of the lock receiving portion 22. Therefore, this results a state where the pivoting of the discharge outlet door 16 in the opening direction (lower side in FIG. 4) is restricted, resulting a state where the discharge outlet door 16 is locked in the closed state. Because the discharge outlet door 16 is reliably held in the closed position by the lock device 20, it is possible to prevent fluttering caused by the blowing pressure (blowing by rotation) generated by the rotation of the mowing blade 5. Because the closed state of the discharge outlet door 16 is locked by the lock device 20, it is possible to set the resilient force of the torsion spring 18 to be weaker than the prior art. By setting the resilient force of the torsion spring 18 to be weaker, the user can easily open the discharge outlet door 16 by a smaller force than required in the prior art, and therefore, the usability of the lawn mower 1 is improved in this respect.

For opening the discharge outlet door 16 from the lock state shown in FIG. 4, the user may pinch the knob portion 21b and may slide the lock member 21 in an unlock direction (rearward). This sliding operation is performed against the biasing force of the compression spring 23. As the lock member 21 is slid in the unlock direction, its tip end portion retracts rearward relative to the tip end portion of the lock receiving portion 22, and therefore, it is possible to open the discharge outlet door 16 (downward movement in FIG. 4) without causing interference of the lock member 21 with the lock receiving portion 22. The opening operation of the discharge outlet door 16 is performed against the biasing force of the torsion spring 18. By opening the discharge outlet door 16, the discharge duct can be attached to the lateral-side discharge outlet 15.

When the holding operation at the open position by the user is released, the discharge outlet door 16 may be closed by the biasing force of the torsion spring 18. During the closing stage of the discharge outlet door 16, the guide inclined surface 21a of the lock member 21 may slidably contact the guide inclined surface 22a of the lock receiving portion 22 as indicated by two-dot chain lines in FIG. 4, so that the lock member 21 moves toward the unlock side against the biasing three of the compression spring 23. Because the discharge outlet door 16 is closed by the biasing force of the torsion spring 18 while causing movement of the lock member 21 toward the unlock side, the tip end portion of the lock member 21 enters the inner side (upper side in FIG. 4) of the lock receiving portion 22 as indicated by solid lines in FIG. 4, whereby the discharge outlet door 16 is brought to a state where it is locked at the closed position. In this way, when the discharge outlet door 16 is closed, the discharge outlet door 16 can be automatically locked at the closed position by the lock device 20.

According to the lock device 20 of the first embodiment configured as described above, the discharge outlet door 16 is reliably locked at the closed position. Therefore, in comparison with the construction in which the closed position is held only by the biasing force of the torsion spring, it is possible to reliably prevent fluttering of the discharge outlet door 16. Because the fluttering is prevented by the lock device 20, it is possible to set the biasing force of the torsion spring 18 to be weaker. Therefore, it is possible to easily open the discharge outlet door 16 by a smaller force than in the prior art, and as a result, it is possible to improve the usability of the lawn mower 1 in this respect.

Further, the discharge outlet door 16 is locked at the closed position by the lock device 20. The unlock operation of the lock device 20 is caused by the unlock operation of the lock member 21 by the user. Therefore, it is possible to reliably prevent the discharge outlet door 16 from accidental opening movement in comparison with the construction in which the discharge outlet door is held at the closed position only by the torsion spring.

Further, by releasing the hand from the discharge opening door 16 in the open position, the discharge outlet door 16 may be closed by the biasing force of the torsion spring 18. During the stage of the closing movement, the lock member 21 enters the inner side of the lock receiving portion 22 due to the mutual slide contact action between the guide inclined surfaces 21a and 22a, whereby the discharge outlet door 16 is automatically locked at the closed position by the lock device 20. Because the discharge outlet door 16 is automatically locked at the closed position by the lock device 20 when the discharge outlet door 16 is closed, it is not necessary for the user to intentionally perform the lock operation for the lock device 20. Therefore, the improvement in the usability of the lawn mower 1 is ensured in this respect.

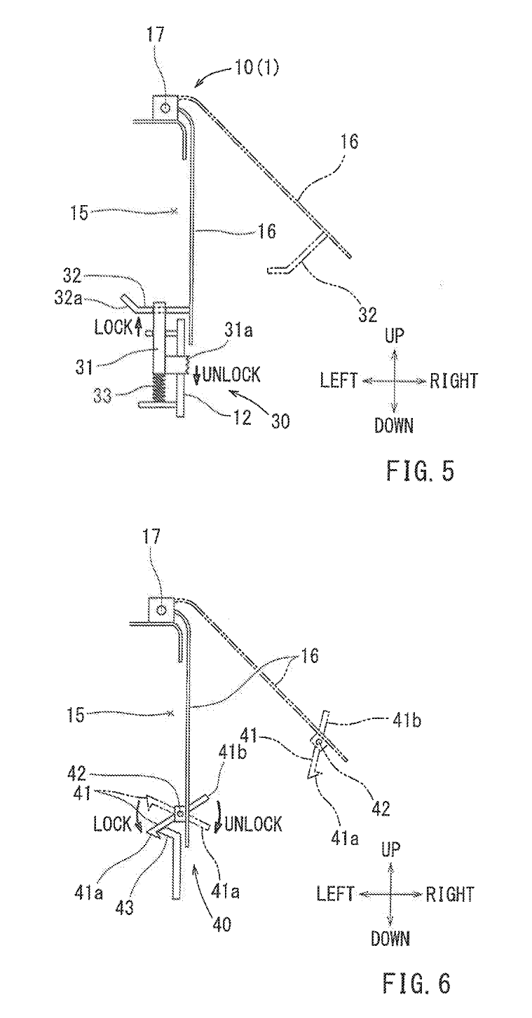

The embodiment described above may be modified in various ways. For example, as a lock device for locking the discharge outlet door 16 at the closed position, it may be possible to use variously configured lock devices in place of the lock device 20 exemplified in the first embodiment. FIG. 5 shows a lock device 30 according to a second embodiment. The lock device 30 may be provided with a lock member 31 disposed on the side of the lateral-side discharge outlet 15, and a lock receiving portion 32 disposed on the side of the discharge outlet door 16. The lock member 31 is supported by the body housing 12 at a position on the lower side of the lateral-side discharge outlet 15 such that it can move in the up and down directions. The lock member 31 may be biased to move upward (lock side) by the biasing force of a compression spring 33. The lock member 31 may be provided with a knob portion 31a. The user can move the lock member 31 downward (unlock side) against the compression spring 31 by pinching the knob portion 31a.

The lock receiving portion 32 may be provided with a lock hole into which the lock member 31 can enter. When the lock member 31 enters the lock holed of the lock receiving portion 32 as indicated by solid lines in FIG. 5, the discharge outlet door 16 may be locked at the closed position. When the user pinches the knob portion 31a and pushes the lock member 31 downward to the unlock position located on the lower side against the biasing force of the compression spring 33, the lock member 31 may be removed from the lock hole of the lock receiving portion 32, so that the discharge outlet door 16 can be opened upward. Similar to the first embodiment, the discharge outlet door 16 may be opened against the biasing force of the torsion spring 18.

When the hand is released from the discharge outlet door 16 in the open state, the discharge outlet door 16 returns to the closed position on the lower side by the biasing force of the torsion spring 18. During returning of the discharge outlet door 16 to the closed position, a guide inclined portion 32a of the lock receiving portion 32 slidably contacts the upper end portion of the lock member 31, so that the lock member 31 is pushed downward against the biasing force of the compression spring 33. After that, when the discharge outlet door 16 reaches the closed position, the tip end portion of the lock member 31 is inserted into the lock hole of the lock receiving portion 32, so that the discharge outlet door 16 is locked at the closed position.

In this way, also according to the lock device 30 of the second embodiment, the discharge outlet door 16 is opened by the unlock operation of the user, and therefore, it is possible to reliably prevent the discharge outlet door 16 from accidental opening movement. Further, when the discharge outlet door 16 is closed, the discharge outlet door 16 is automatically locked at the closed position by the lock device 30 without need of any operation by the user, and therefore, the lock operation may not be get forgot, so that it is possible to obviate the accidental opening operation of the discharge outlet door 16. Further, similar to the first embodiment, the closed state of the discharge outlet door 16 is locked by the lock device 30, and therefore, the biasing force of the torsion spring 18 for holding the discharge outlet door 16 at the closed position can be set to be weak, so that it is possible to easily open the discharge outlet door 16 by a small force, and as a result, it is possible to improve the usability of the lawn mower 1 in this respect.

FIG. 6 shows a lock device 40 according to a third embodiment. The lock device 40 of the third embodiment may be provided with a lock arm 41 disposed on the discharge outlet door 16. The lock arm 41 is supported such that it can swing in the up and down directions about a support shaft 42. An engaging claw portion 41a may be provided on a front side (left side in FIG. 6) of the lock arm 41. The rear side (right side in FIG. 6) of the lock arm 31 protrudes laterally from the discharge outlet door 16. The rear portion side of the lock arm 31 may be configured as a knob portion 41b that may be pinched by the user when the moving operation in the up and down directions is performed. By a torsion spring fitted around the support shaft 42, the lock arm 41 may be biased in such a direction that the side of the engaging claw portion 41a moves downward.

A lock receiving portion 43 may be disposed at the body housing 12 on the lower side of the lateral-side discharge outlet 15. As indicated by solid lines in FIG. 6, in a state where the discharge outlet door 16 is closed, there has been resulted a lock state where the lock arm 41 has swung by the biasing force of the torsion spring in such a direction that the side of the engaging claw portion 41a moves downward. In this lock state, the engaging claw portion 41a engages the lock receiving portion, so that the discharge outlet door 16 is brought to a state where it is locked at the closed position.

In order to open the discharge outlet door 16, the user may pinch and press the knob portion 41b downward to cause the lock arm 41 to swing in such a direction that its engaging claw portion 41a moves upward (unlock direction) as indicated by two-dot chain lines in FIG. 6. In this state where the unlock operation has been performed, the user may pull the lock arm 41 toward him, so that the discharge outlet door 16 can be opened.

When the hand is released from the discharge outlet door 16 in the open state, the discharge outlet door 16 pivots in the closing direction by the biasing force of the torsion spring 18. Immediately before the discharge outlet door 16 is closed, the engaging claw portion 41a of the lock arm 41 moves over and engages the lock receiving portion 43, so that the discharge outlet door 16 can be automatically locked at the closed position.

In this way, also according to the lock device 40 of the third embodiment, in order to open the discharge outlet door 16 locked at the closed position, it is necessary for the user to press the knob portion 41a downward for the unlocking operation of the lock device 40. For this reason, it is possible to prevent the discharge outlet door 16 from being accidentally opened by the blowing pressure, vibrations, etc. generated by the rotation of the mowing blade 5. Further, by the lock device 40, the closed state of the discharge outlet door 16 is automatically locked, and therefore, it is possible to obviate troubles such as forgetting of the lock operation. Hence, also in this respect, it is possible to avoid accidental opening or fluttering of the discharge outlet door 16. Further, because the closed state of the discharge outlet door 16 is locked by the lock device 40, the torsion spring 18 can be set to be weak to enable the discharge outlet door 16 to be easily opened by a smaller force for improving the usability of the lawn mower 1.

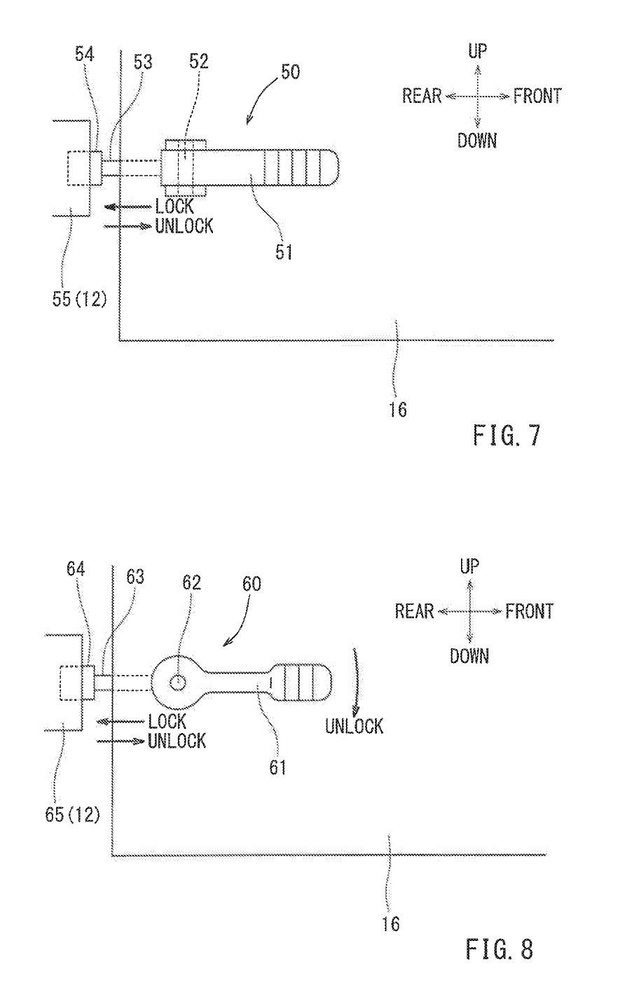

FIG. 7 shows a lock device 50 according to a fourth embodiment. The lock device 50 of the fourth embodiment may be provided with a handle 51. The handle 51 is disposed near the corner portion on the rear side of the lower portion of the discharge outlet door 16. The handle 51 is supported by a support shaft 52 so as to be pivotable in the horizontal direction. An engaging portion 54 may be joined to the handle 51 via a link lever 53. On the other hand, a lock receiving portion 55 may be disposed at the body housing 12 on the side of the lateral-side discharge outlet 15. A torsion spring, the illustration of which is omitted, adapted to hold the lock position may bias the handle 51 to pivot toward a lock position located along the discharge outlet door 16. FIG. 7 shows a state where the handle 51 has returned to the lock position. As the handle 51 is pivoted in the horizontal direction (a direction perpendicular to the sheet surface of the drawing), the engaging portion 54 advances and retracts in the front-to-rear direction relative to the lock receiving portion 55 as indicated by arrows in the drawing.

When the user pulls the handle 51 toward him from the lock position shown in the drawing against the biasing force of the torsion spring that is adapted to hold the lock position, the engaging portion 54 retracts forwardly from the lock receiving portion 55, so that the lock device 50 is unlocked. Therefore, the user can open the discharge outlet door 16 by pivoting it upward while he keeps the handle 51 to be pulled toward him. Similar to the first to third embodiments, the opening operation of the discharge outlet door 16 may be performed against the biasing force of the torsion spring 18.

As the discharge outlet door 16 is closed from the open state, the engaging portion 54 moves over the lock receiving portion 55 against the biasing force of the torsion spring that is adapted to hold the lock position, due to an inclined surface action similar to that of the guide including surfaces 21a and 22a of the second embodiment, so that the discharge outlet door 16 can be automatically locked at the closed position.

FIG. 8 shows a lock device 60 according to a fifth embodiment. Similar to the fourth embodiment, the lock device 60 of the fifth embodiment may be disposed near the corner portion on the rear side of the lower portion of the discharge outlet door 16. A handle 61 of the fifth embodiment may be arranged so as to be liftable in the up and down directions via a support shaft 62. The handle 61 is biased toward a lock position by a torsion spring, the illustration of which is omitted. FIG. 8 shows a state where the handle 61 has returned to the lock position. Tilting the handle 61 downward as indicated by an arrow in FIG. 8 can cause an unlocking operation of the lock device 60.

Similar to the fourth embodiment, an engaging portion 64 may be joined to the handle 61 via a link lever 63, and a lock receiving portion 65 may be disposed at the body housing 12 on the side of the lateral-side discharge outlet 15. When the user grasps the handle 61 and tilts it downward, the engaging portion 64 retracts forward from the lock receiving portion 65. Therefore, the user can open the discharge outlet door 16 upward by pulling the handle 61 toward him while he keeps the handle 51 to be tilted toward the unlock side.

Similar to the fourth embodiment, as the discharge outlet door 16 is closed from the open state, the engaging portion 64 moves over and engages the lock receiving portion 65 due to an inclined surface action between the engaging portion 64 and the lock receiving portion 65, so that the discharge outlet door 16 can be automatically locked at the closed position.

In this way, according to the fourth and fifth embodiments, the discharge outlet door 16 can be locked at the closed position by the lock devices 50 and 60, and therefore, it is possible to prevent the discharge outlet door 16 from fluttering by the blowing pressure, vibrations, etc. generated by the rotation of the mowing blade 5, and it is also possible to obviate accidental opening. Further also in the fourth and fifth embodiments, when the discharge outlet door 16 is closed, the closed state can be automatically locked by the lock devices 50 and 60, and therefore, it may not occur that the lock operation is forgot, and in this respect, it is possible to prevent accidental opening after that. Further, by setting the biasing force of the torsion spring 18 to be weak, the discharge outlet door 16 can be easily opened by a smaller force, and the usability of the lawn mower 1 can be improved in this respect.

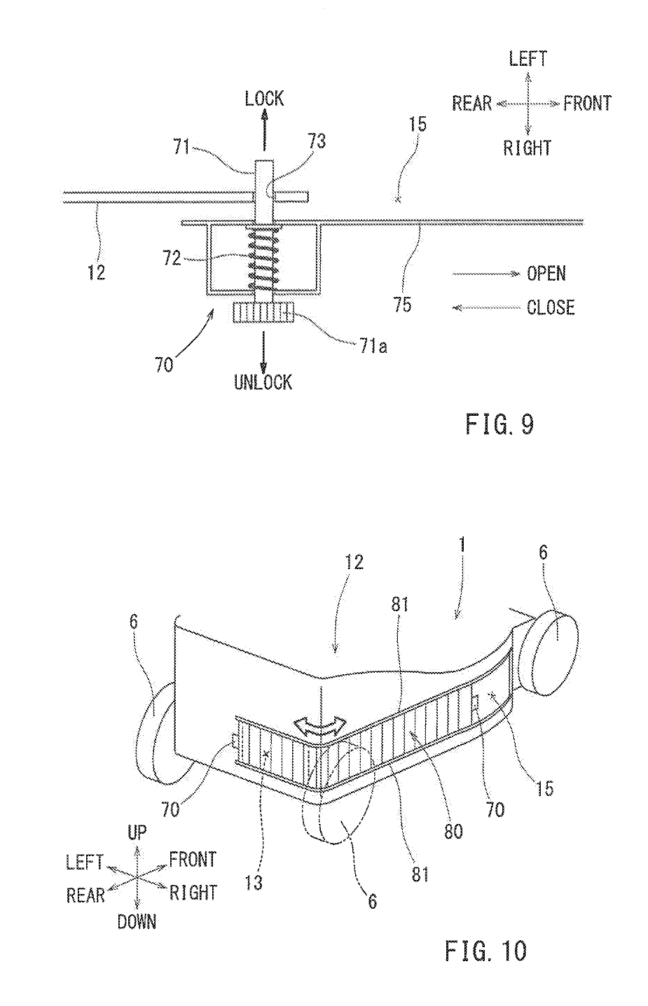

FIG. 9 shows a lock device 70 according to a sixth embodiment. The lock device 70 of the sixth embodiment may lock a discharge outlet door 75 at a closed position. The discharge outlet door 75 is of a front-to-rear slidable type and is different from the discharge outlet door 16 that is of an up-to-down pivotable type. In the case of the sixth embodiment, the discharge outlet door 75 can open the lateral-side discharge outlet 15 by being slid forward and can close the discharge outlet door 75 by being slid rearward. The lock device 70 of the sixth embodiment may be provided with a lock pin 71. The lock pin 71 is axially movably supported on the rear portion side of the discharge outlet door 75. The lock pin 71 may be locked as it is moved axially upward in FIG. 9, and the lock pin 71 may be unlocked as it is moved axially downward. The lock pin 71 may be biased toward a lock side (upper side in the drawing) by a compression spring 72. A knob portion 71a may be provided on a head portion of the lock pin 71 and may be adapted to be pinched by the user when he performs an unlock operation.

A lock hole 73 may be disposed in the body housing 12 at a position on the rear side of the lateral-side discharge outlet 15. If the tip end of the lock pin 71 is inserted into the lock hole 73 when the discharge outlet door 75 is closed as shown in the drawing, the discharge outlet door 75 is brought into a locked state at the closed position. The discharge outlet door 75 can be slid in the opening direction if the user pinches the knob portion 71a and pulls the lock pin 71 toward the unlock side (downward in FIG. 9) against the biasing force of the compression spring 72 in order to pull the tip end portion of the lock pin 71 out of the lock hole 73. When the user closes the discharge outlet door 75 by sliding it rearward from the open position, the tip end portion of the lock pin 71 is inserted into the lock hole 73 by the biasing force of the compression spring 72, so that the closed position can be automatically locked.

In this way, according to the lock device 70 of the sixth embodiment, it is possible to lock at the closed state the discharge outlet door 75 of a front-to-rear slidable type which is different from the discharge outlet door 16 of an up-to-down pivotable type as in the first to fifth embodiments. Also with the lock device 70 of the sixth embodiment, it is possible to prevent the discharge outlet door 75 from fluttering and to obviate accidental opening. The lock device 70 of the sixth embodiment can be applied to a discharge outlet door of an up-to-down slidable type or a surface-direction pivotable type (a configuration in which the discharge outlet door is opened and closed as it is pivoted in a surface direction), other than the discharge outlet door 75 of the front-to-rear slidable type as exemplified above.

FIG. 10 shows a discharge outlet door 80 that is of a developed configuration from the discharge outlet door 75 of the front-to-rear slidable type. The discharge outlet door 80 may have a function of opening and closing both the rear-side discharge outlet 13 disposed at the rear portion of the body housing 12 and the lateral-side discharge outlet 15 disposed at the right side portion of the body housing 12. A shutter-type door component flexible by a substantially right angle in the lateral direction may be used as the discharge outlet door 80. As indicated by an outline arrow in FIG. 10, the discharge outlet door 80 may be slid to extend between the rear portion and the right side portion of the body housing 12.

The lateral-side discharge outlet 15 may be closed by the front portion side of the discharge outlet door 80 and the rear-side discharge outlet 13 is closed by the rear portion side of the discharge outlet door 80. The rear-side discharge outlet 13 may be opened when the discharge outlet door 80 is slid forward to close the lateral side discharge outlet 15. On the contrary, the rear-side discharge outlet 13 may be closed when the discharge outlet door 80 is slid rearward to open the lateral side discharge outlet 15. FIG. 10 shows the state where the discharge outlet door 80 has been slid rearward to close the rear-side discharge outlet 13, while the lateral-side discharge outlet 15 is open. In this way, with the discharge outlet door 80, the closing operation of one of the rear-side discharge outlet 13 and the lateral-side discharge outlet 15 and the opening operation of the other of them can be simultaneously performed by a single sliding operation.

The discharge outlet door 80 may be slidably supported by upper and lower slide rails 81 that are arranged to extend between the right side portion and the rear portion of the body housing 12. The lock device 70 exemplified above is disposed at each of the front portion and the rear portion of the discharge outlet door 80. The lock hole 73 may be disposed at the body housing 12 on each of the left side of the rear-side discharge outlet 13 and the front side of the lateral-side discharge outlet 15 to correspond to the front and rear lock devices 70. The discharge outlet door 80 can be slid in the front and rear directions in the state where the lock pins 71 of both of the lock devices 70 on the front and rear sides have been pulled out of the lock holes 73 against the biasing forces of the compression springs 72, respectively (unlock operation). When the discharge outlet door 80 is slid forward to close the lateral-side discharge outlet 15, the lock pin 71 of the front side lock device 70 is inserted into the lock hole 73, resulting the state where the closed state is automatically locked. When the discharge outlet door 80 is slid rearward to close the rear-side discharge outlet 13, the lock pin 71 of the rear side lock device 70 is inserted into the lock hole 73, resulting the state where the closed state is automatically locked.

With the discharge outlet door 80 exemplified above, the opening and closing operations of the rear-side discharge outlet 13 and the lateral-side discharge outlet 15 can be performed at one time by a single sliding operation. For this reason, the detaching and attaching operations of the grass collecting box 3 on the rear portion side and the discharge duct on the side of the right side portion can be rapidly and easily performed. Therefore, the usability of the lawn mower 1 can be further improved in this respect.

It may be possible to make further modifications to the embodiments described above. For example, although the lawn mower 1 of a type having the lateral-side discharge outlet 15 on the right side has been exemplified, it may be possible to apply the exemplified lock devices to a lawn mower having a discharge outlet on the left side or both on the left and right sides.

Further, although the illustration is omitted, an electronic lock device may be used as the lock device for locking the discharge outlet door at the closed position. As the electronic lock device, it may be possible to use, for example, an electronic lock device of a type unlocked by a pushing operation of an unlock button or of a type unlocked by reading a card key.

Further, although the lawn mower 1 having the engine 4 as a drive source has been exemplified, the exemplified lock devices can be also applied to an electrically driven lawn mower that has an electric motor as a drive source and that can use a rechargeable battery as a power source.

1-5. (canceled)

6. A lawn mower comprising:
a rotary mowing blade;
a housing covering a periphery of the mowing blade;
wherein the housing includes a discharge outlet for discharging lawn mown by the mowing blade;
a discharge outlet door attached to the housing and configured to open and close the discharge outlet; and
a lock device configured to lock and unlock the discharge outlet door at a closed position.

7. The lawn mower as defined in claim 6, further comprising a biasing device configured to bias the discharge outlet door in a closing direction, wherein the lock device is further configured to lock the discharge outlet door at the closed position when the discharge outlet door is closed by the biasing force.

8. The lawn mower as defined in claim 6, wherein the discharge outlet is disposed at least one of a rear portion and a lateral portion of the housing.

9. The lawn mower as defined in claim 6, wherein the rotation of the mowing blade is stopped when the lock device is operated to be unlocked.

10. The lawn mower as defined in claim 6, wherein:
the discharge outlet comprises a first discharge outlet and a second discharge outlet, the first discharge outlet being disposed at a rear portion of the housing, and the second discharge outlet being disposed at a lateral portion of the housing;
the discharge outlet door includes a first door portion and a second door portion, the first door portion being configured to open and close the first discharge outlet, and the second door portion being configured to open and close the second discharge outlet;
the lock device comprises a first lock device and a second lock device, the first lock device being configured to lock and unlock the first door portion at a closed position, and the second lock device being configured to lock and unlock the second door portion at a closed position;
the first door portion and the second door portion are coupled to each other, so that (a) the first door portion is positioned at an open position for opening the first discharge outlet when the second door portion is positioned at the closed position and (b) the first door portion is positioned at the closed position when the second door portion is positioned at an open position for opening the second discharge outlet.

11. The lawn mower as defined in claim 10, wherein the first lock device is configured to automatically lock the first door portion when the first door portion is at the closed position, and the second lock device is configured to automatically lock the second door portion when the second door portion is at the closed position.

12. The lawn mower as defined in claim 10, wherein the first door portion and the second door portion are joined to each other, so that (a) the first door portion moves from the open position to the closed position as the second door portion moves from the closed position to the open position and (b) the first door portion moves from the closed position to the open position as the second door portion moves from the open position of the closed position.
